(19) United States
(12) Patent Application Publication
(10) Pub. No.: US 2010/0211870 A1
(43) Pub. Date: Aug. 19, 2010

(54) DOCUMENT DISPLAY DEVICE AND METHOD

(75) Inventor: Kenji Ishii, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/648,830

(22) Filed: Dec. 29, 2009

(30) Foreign Application Priority Data
Feb. 19, 2009 (JP) 2009-036105

(51) Int. Cl. G06F 17/00

(52) U.S. Cl. 715/243

(57) ABSTRACT

A device for displaying an image according to a document including a plurality of block elements on a display screen, each block element defining an image of an object having a size relative to the size of the screen when displayed, the object being capable of being overlaid with a text or another image of another object, includes: a data acquisitor for obtaining the document; and a processor for executing a process including: extracting the block elements from the document; determining at least one of the block elements defining an image of an object to be displayed on the display screen on the basis of size of the image of an object; and displaying the image of the object defined by the at least one of the block elements determined together with any associated text or another image object of another object overlaid onto the image of the object.

### CROSS-REFERENCE TO RELATED APPLICATION

This application is based upon and claims the benefit of priority of the prior Japanese Patent Application No. 2009-036105, filed on Feb. 19, 2009 the entire contents of which are incorporated herein by reference.

### FIELD

The embodiment discussed herein is related to a document display device for displaying a document on a screen.

### BACKGROUND

A mobile phone user today quite often reads a blog or a bulletin board displayed on a screen of the mobile phone. Although resolution of the mobile phone screen has improved to a level of a former personal computer, the screen is still small and thus causes a problem that the screen is hard to read for the user. The mobile phone screen is used for displaying a document in a state being vertically longer than is horizontally wide. Some mobile phone is used for displaying a document in a state being horizontally wider than is vertically long.

In a case where a document is displayed on the basis of a blog or a bulletin board on the Internet written in a markup language such as HTML, XHTML, etc., on a mobile phone screen directed horizontally wider than is vertically long, a user needs to quite often vertically scroll the screen and the document is hard to read. Meanwhile, in a case where a document is displayed on a mobile phone screen directed vertically longer than is horizontally wide, the user needs to quite often horizontally scroll the screen and the document is harder to read.

FIG. 12A illustrates an example of a document structure in document data such as a blog, etc., written in a markup language. An area enclosed by a rectangle is an area of a frame element specified by the markup language, a table element specified by the markup language or a block element specified by a style sheet. A title of the blog, a title of the body of the document, the body of the blog document, etc., are written in areas A, B and C, respectively. A calendar, a latest article, a latest comment, a latest track back and so on are written in areas D and E.

FIG. 12B illustrates a position of a mobile phone screen F for displaying a document on a screen that is horizontally wider than is vertically long. FIG. 12C illustrates a position of a mobile phone screen G for displaying a document on a screen that is vertically longer than is horizontally wide.

The display on the screen F illustrated in FIG. 12B requires a user to quite often vertically scroll the screen so as to read the body of the document. The display on the screen G illustrated in FIG. 12C requires a user to quite often horizontally scroll the screen so as to read the body of the document.

As illustrated in FIG. 13A, a mobile phone that displays a screen is provided with a mobile display mode in which a document such as a blog is displayed in accordance with the mobile phone screen in order not to be horizontally scrolled. In the mobile display mode, a block element specified by a style sheet is vertically displayed so that scrolling in the horizontal direction is unnecessary. In this case, a portion of the document that a user wants to read is positioned below, and a horizontal width of the portion that the user wants to read is narrow, and there is inconvenience that the screen needs to be quite often vertically scrolled. In some cases, as illustrated in FIG. 13B, the areas D and E are displayed separately up and down depending on a format of the document data written in the markup language.

In a case where a document structure of document data such as a blog is formed by frame elements, a user can choose a particular one of the frame elements so that the only a document that corresponds to the chosen frame element is displayed on the mobile phone screen. A document such as a blog is, however, not necessarily formed by frame elements, and the mobile phone cannot merely display the portion that the user wants to read.

A text area included in a screen is sometimes displayed such that the text is wrapped in accordance with a width of the screen so as to be contained in the screen and to enable the user to read the document only by vertically scrolling.

In any case, as the mobile phone does not merely display the portion that the user wants to read, there still remains inconvenience that the screen needs to be quite often vertically scrolled if there is a portion that the user wants to read below.

Japanese Laid-open Patent Publication No. 2005-527057 discloses a method for presenting an HTML document on a display unit of a client-use small screen terminal. According to this method, the terminal applies at least one client-side style sheet and matches a width of a document after reconfiguration to a width of the display screen of the client-use small screen terminal so as to reconfigure the HTML document and present the document after the reconfiguration. The terminal can thereby display the HTML document on the small sized display.

According to Japanese Laid-open Patent Publication No. 2005-527057, however, as the terminal does not merely display the portion that the user wants to read, there still remains inconvenience that the screen needs to be quite often vertically scrolled if there is a portion that the user wants to read below.

### SUMMARY

According to an aspect of the invention, a device for displaying an image according to a document including a plurality of block elements on a display screen, each block element defining an image of an object having a size relative to the size of the screen when displayed, the object being capable of being overlaid with a text or another image of another object, includes: a data acquisitor for obtaining the document; and a processor for executing a process including: extracting the block elements from the document; determining at least one of the block elements defining an image of an object to be displayed on the display screen on the basis of size of the image of an object; and displaying the image of the object defined by the at least one of the block elements determined together with any associated text or another image object of another object overlaid onto the image of the object.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration of a document display device according to an embodiment of the invention.

FIG. 2 illustrates a structure of a markup document to be used for the document display device illustrated in FIG. 1 and an example of a displayed screen.

FIG. 3A, FIG. 3B, and FIG. 3C illustrate another example of a displayed screen of a markup document to be displayed on the document display device illustrated in FIG. 1.

FIG. 4 illustrates a processing flow of a mobile display mode performed by the document display device illustrated in FIG. 1.

FIG. 5 illustrates an analysis process of the document structure in the processing flow illustrated in FIG. 4.

FIG. 6 illustrates a former portion of a processing flow of a block element calculating function illustrated in FIG. 5.

FIG. 7 illustrates a latter portion of the processing flow of the block element calculating function illustrated in FIG. 5.

FIG. 8 illustrates a processing flow with respect to calculation of a drawing size and determination of a block element to be area-focused illustrated in FIG. 4.

FIG. 9 illustrates a processing flow with respect to a visible/hidden process and a change of the drawing size illustrated in FIG. 4.

FIG. 10A and FIG. 10B illustrate a process with respect to a visible/hidden process and a change of size illustrated in FIG. 8.

FIG. 11A, FIG. 11B and FIG. 11C illustrate an effect due to a document structure analysis in the document display device illustrated in FIG. 1.

FIG. 12A illustrates a document structure of a markup document.

FIG. 12B and FIG. 12C illustrate an example of a form for displaying a markup document according to the related art.

FIG. 13A and FIG. 13B illustrate another example of a form for displaying a markup document according to the related art.

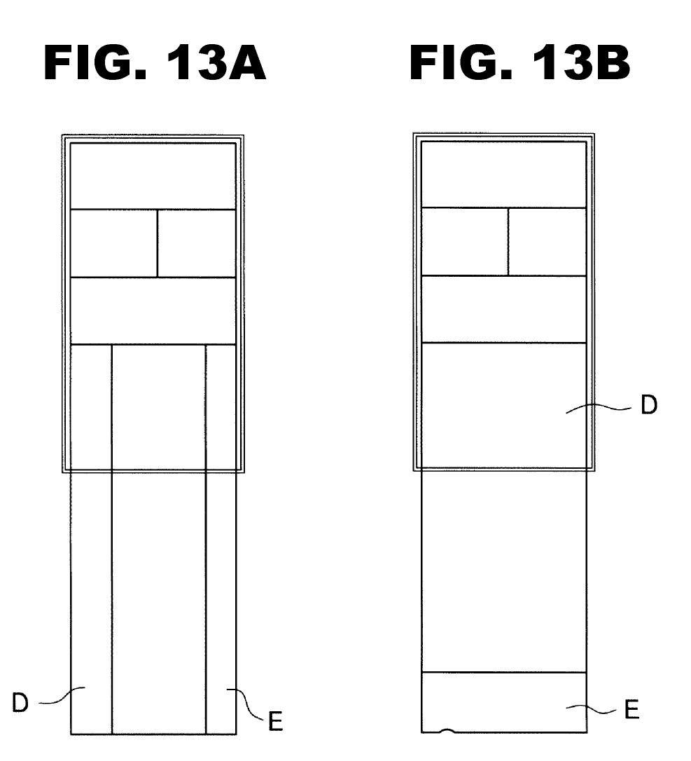

### DESCRIPTION OF THE EMBODIMENT

A document display device and a method for displaying a document of the invention will be explained hereafter.

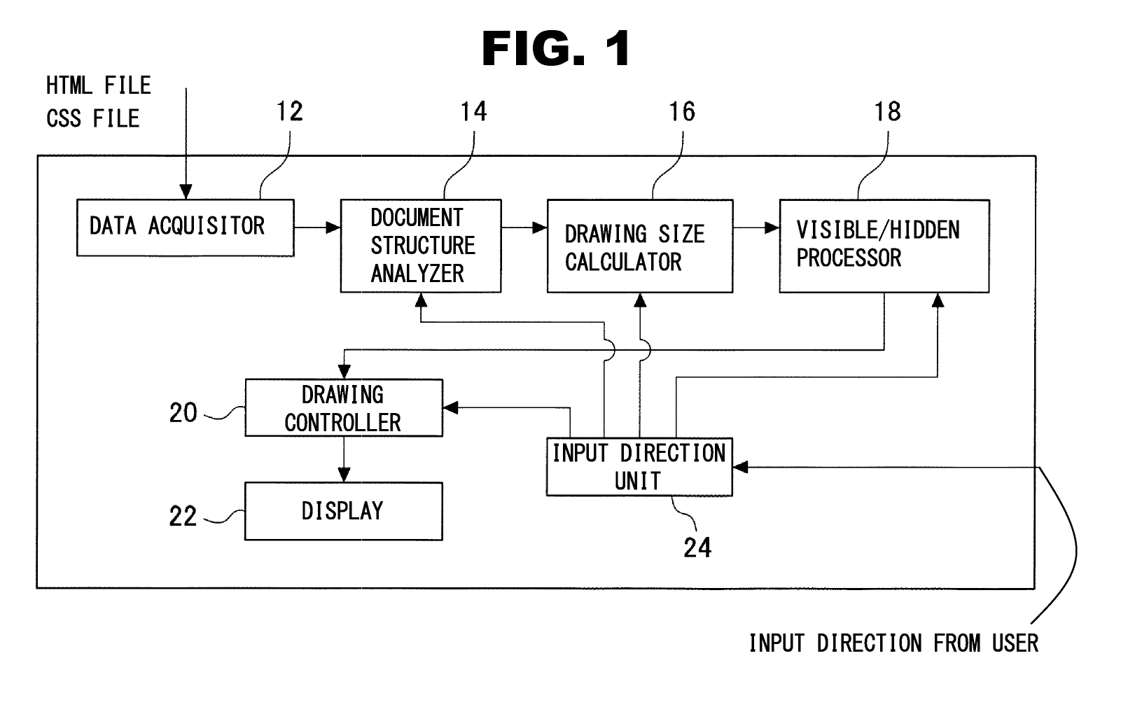

FIG. 1 is a functional block diagram illustrating a document display device 10 integrated in a mobile terminal apparatus such as a mobile phone or a PDA.

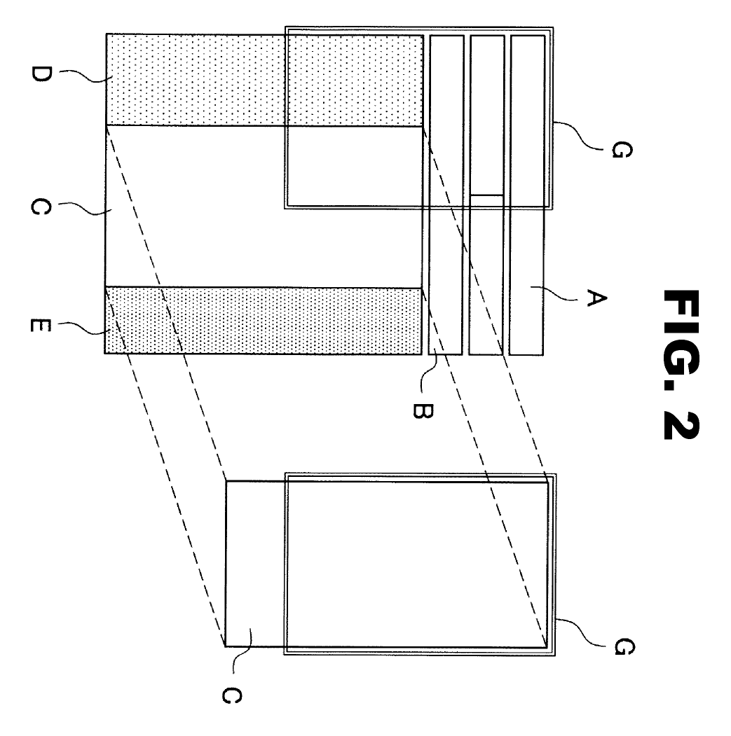

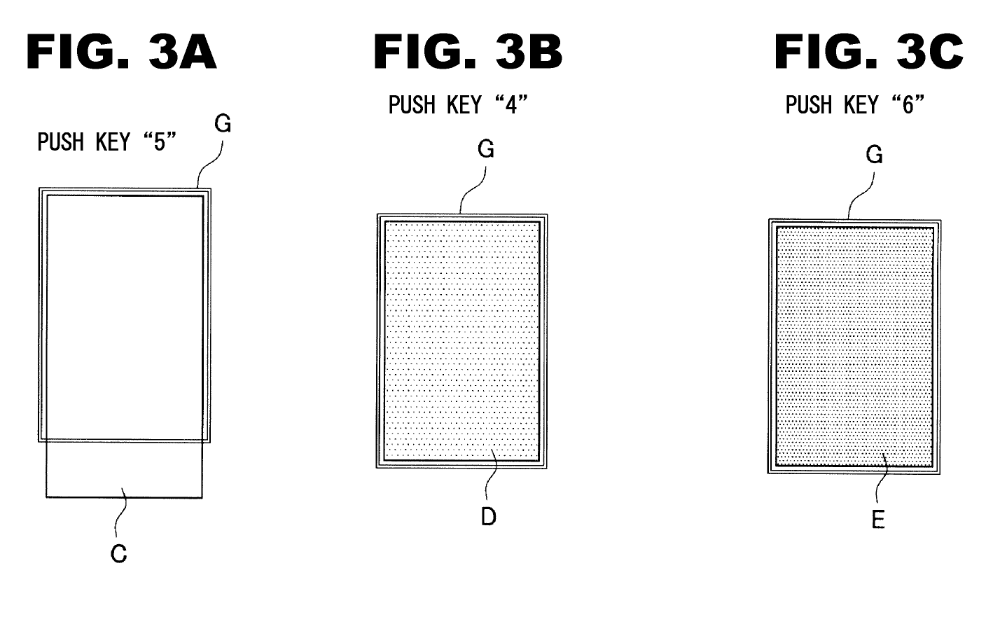

FIG. 2 illustrates a document data structure in a document such as a blog written in a markup language (called a markup document hereafter) and an example of a displayed screen of the document display device 10. FIG. 3A, FIG. 3B, and FIG. 3C illustrate another example of a displayed screen of the document display device 10. The document includes a plurality of block elements on a display screen.

Each of the block elements defined an image of an object may include a size relative to the size of the screen when displayed. The object may be overlaid with a text or another image of another object.

(Explanation of Functions of the Document Display Device)

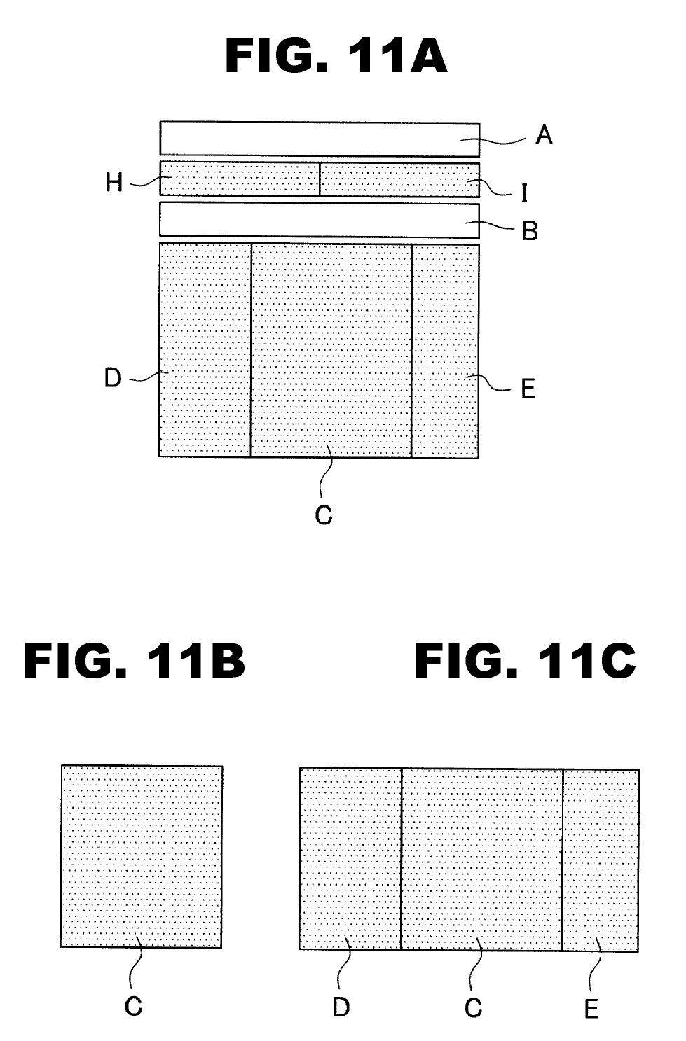

Document data of a markup document is usually made in a document size according to a width of a screen of a PC (personal computer), and is displayed on the PC and so on in a display form according to the screen of the PC (PC display mode). A display form of the document display device 10 illustrated in FIGS. 2 and 3 is, however, based on a mobile display mode in which a document is displayed in accordance with a width of a screen G of the mobile terminal apparatus. In this mobile display mode, an area of the body of the document that a user wants to read is displayed. The document display device 10 adapted for such a display will be explained hereafter. Incidentally, the document structure illustrated in FIG. 2 is same as a document structure illustrated in FIG. 11A.

The document display device 10 is a device configured to display a markup document of the Internet content on a client-use terminal screen (simply called the screen hereafter) on the basis of the document data. The document display device 10 has a function for displaying on the screen G a portion of the markup document arranged in a particular element C as illustrated in FIG. 2, and further has a function for moving from the document arranged in the particular element C to a document arranged in an adjacent element D or E and for displaying the document as illustrated in FIG. 3A, FIG. 3B, and FIG. 3C. The document display device 10 can efficiently display on a screen an area of the body of the document that a user wants to read.

(Explanation of a Configuration of the Document Display Device)

The document display device 10 has a data acquisitor 12, a document structure analyzer 14, a drawing size calculator 16, a visible/hidden processor 18, a drawing controller 20, a display 22 and an input direction unit 24. The document display device 10 may include a memory for storing the document data. The document display device 10 may execute a process including: extracting the plurality of the block elements from the document; determining at least one of the plurality of the block elements defining an image of an object to be displayed on the display screen on the basis of size of the image of an object; and displaying the image of the object defined by the at least one of the block elements determined together with any associated text or another image object of another object overlaid onto the image of the object.

The data acquisitor 12 obtains document data of a markup document of the Internet content received by the mobile terminal apparatus as an HTML file. The markup language includes HTML, XHTML, XML and so on. Unless the obtained document describes a display form therein by using a style sheet, the data acquisitor 12 reads and obtains a CSS (Cascading Style Sheets) file including the style sheet and an image file. The data acquisitor 12 provides the document structure analyzer 14 with the obtained document data and the style sheet data.

The document structure analyzer 14 detects one of structural elements that are a frame element specified by the markup language, a table element specified by the markup language and a block element specified by the style sheet as an external element. The document structure analyzer 14 further detects, among the above structural elements, an element specified in the external element as an internal element. The external element corresponds, e.g., to a first element. The internal element corresponds, e.g., to a second element.

The frame element specified by the markup is detected with reference to a tag such as <frame> or </frame>. The table element defined by the markup language is detected with reference to a tag such as <table> or </table>. The block element specified by the style sheet is detected with reference to a tag on which, e.g., a property such as id or class is specified for div. The document structure analyzer 14 provides the drawing size calculator 16 with data of the detected external and internal elements as well as the document data and the style sheet data.

If there is a plurality of the detected internal elements, the drawing size calculator 16 specifies one of the plural internal elements having an area of a greatest drawing size. The internal element having the area of the greatest drawing size is caused to be a visible element described later, i.e., an element to be area-focused and displayed on the display 22. If the internal element detected by the document structure analyzer 14 is single, the detected internal element is caused to be an element uniquely area-focused and displayed after the drawing size is specified. The drawing size calculator 16 provides the visible/hidden processor 18 with data of the visible element that has been set as well as the document data, the style sheet data and data of the detected external and internal elements.

The visible/hidden processor 18 sets a visible/hidden condition of the elements such that one of the detected external and internal elements other than the element to be area-focused and displayed is caused to be a hidden element, and changes a width of the visible element such that the width of the visible element area matches the width of the screen G. That is, the visible/hidden processor 18 is a portion configured to change the drawing size. The visible/hidden processor 18 sets the visible/hidden condition by, e.g., setting a property of the element. If “visibility: hidden” is additionally set to the style sheet, e.g., the element is caused to be a hidden element. Unless “visibility: hidden” is set, the element is a visible element. The visible/hidden processor 18 provides the drawing controller 20 with the document data, corrected style sheet data and the data of the detected external and internal elements.

The drawing controller 20 is a portion configured to control a display of the document on the screen G by using the visible/hidden condition that has been set. The drawing controller 20 performs rendering of drawing by, e.g., applying the style sheet for which the visible/hidden property or the drawing size has been changed. Thus, the visible element is displayed on the full screen in accordance with the width of the screen G.

The display 22 has the screen G illustrated in FIG. 2 and displays a document. The screen G is at least narrower and has fewer display dots than a screen of a PC (personal computer). The display 22 is not limited to a single one, and there may be a plurality of the displays 22. If there are the plural displays 22, one for displaying the document exclusively in the mobile display mode in accordance with the width of the screen G and another one for displaying the document exclusively in the PC display mode in accordance with a certain width, e.g., a width of the PC screen, which is wider than the width of the screen G may be separately provided. Other than that, the display 22 may be configured to change over the mobile display mode and the PC display mode to each other on the single display in accordance with an input direction from a user.

The input direction unit 24 receives an input direction that a user wants so that a display on the display 22 is changed over. In a case of a mobile phone, e.g., the input direction unit 24 corresponds to a plurality of numeric keys arranged at a certain position. If a user presses a key of a numeral “5”, the visible element specified to be area-focused is displayed in the mobile display mode, as illustrated in FIG. 3A, FIG. 3B, and FIG. 3C. If the user presses a key of a numeral “4” or “6” under the display condition in the mobile display mode, the display is changed over to a display of an adjacent element.

This process is performed as described below. The visible/hidden processor 18 is provided with data of a user's input direction through the input direction unit 24, e.g., data of the pressed numeric key in the mobile phone case. The visible/hidden processor 18 specifies one hidden element adjacent to the visible element to be area-focused and displayed in accordance with the position at which the one of the plural numeric keys that the user gives the input direction is arranged. After that, the visible/hidden processor 18 sets a condition under which the specified hidden element is caused to be a new visible element and the elements other than the new visible element are caused to be hidden elements. After that, the drawing size of the new visible element is changed in accordance with the width of the screen G. After that, the drawing controller 20 performs rendering of drawing.

The document structure analyzer 14, the drawing size calculator 16, the visible/hidden processor 18 and the drawing controller 20 of the document display device 10 may be software modules implemented as the document display device 10 activates a program by using a process processor and a memory that are not illustrated and each of the above portions works. Other than that, each of the above portions may be a hardware module constituted by an exclusive circuit. Other than that, each of the above portions may be constituted by a software module and a hardware module used together.

(Explanation of a Process in the Mobile Display Mode)

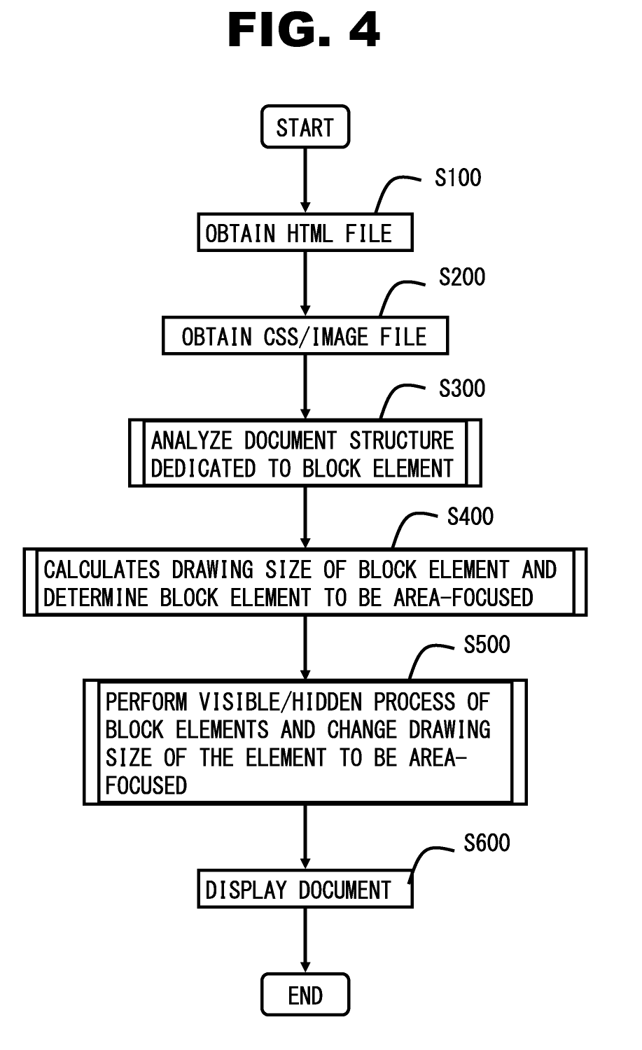

FIG. 4 shows a processing flow performed by the document display device 10 in the mobile display mode.

In the following explanation, an example case where a markup document is an HTML document and the document display device 10 displays the document by using a block element specified by a style sheet will be explained.

The data acquisitor 12 obtains an HTML file received by the mobile terminal apparatus (step S100). The HTML file includes document data of an HTML document.

The data acquisitor 12 obtains a CSS file that includes a style sheet and an image file (step S200). Data of the CSS file and the image file is written in the HTML document, and the data acquisitor 12 obtains the files by using the data.

The document structure analyzer 14 analyzes a document structure dedicated to a block element specified by the style sheet (step S300). Document structure analysis includes detecting a block element, and specifically it is to collect block element data by detecting a block element. The block element data includes data with respect to whether or not a block element exists and data included in a parameter that is used for calling a block element calculating function. In a case where, e.g., a block element exists, the block element data includes the block element total number, a start position (start row) of the block element in the document data of the respective block element, an end position (end row) of the block element, a block element layer, upper block element data and data of a value that specifies the block element. At this stage, the block element is configured to be specified by a numeral in order from 0. A structure of document data such as a blog for which a style sheet is used so that a display form is specified is a layered structure in which a block element (internal block element) is specified in a block element (external block element). Data of the layer of the block element in the layered structure is called the block element layer. External and internal block elements are given layers of, e.g., 1 and 2, respectively. The upper block element data is data for specifying an external block element positioned at an upper layer by a numeral with respect to which external block element the internal block element is specified in.

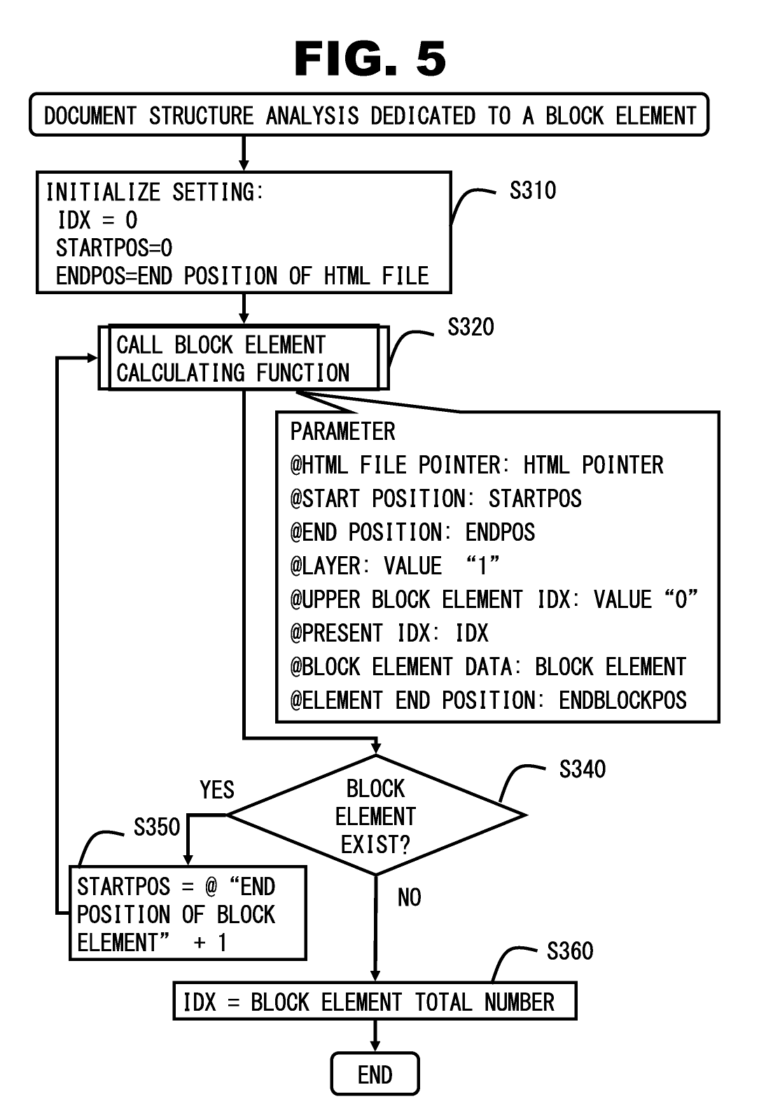

The document structure analysis is performed in accordance with flows illustrated in FIGS. 5-7. The flows of the analysis will be described later.

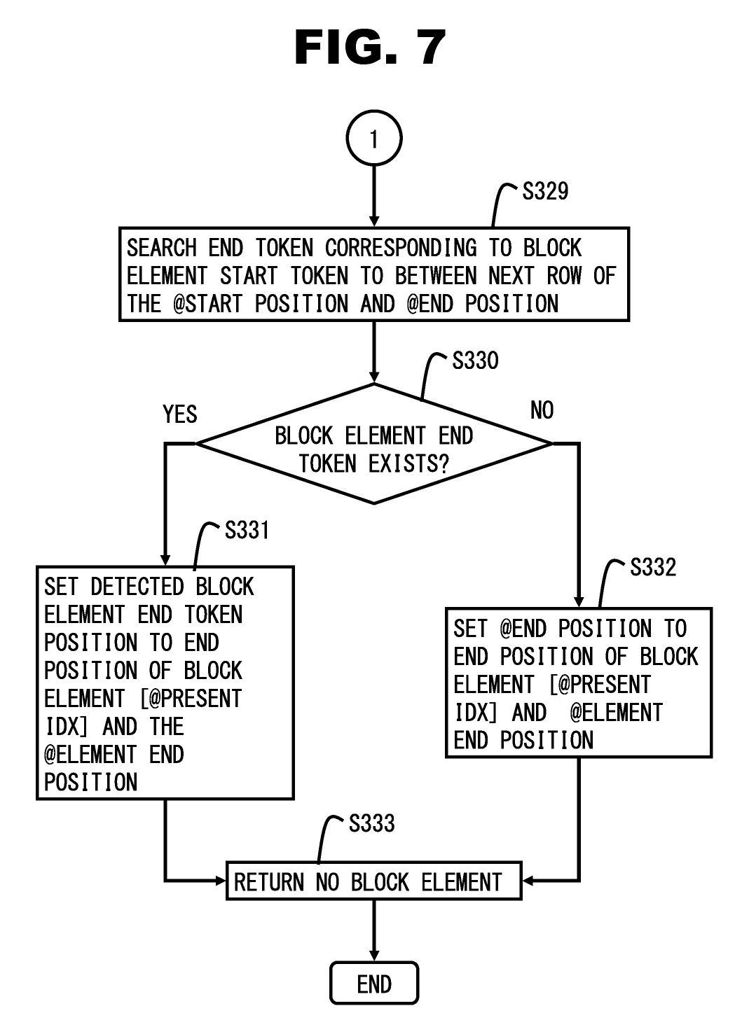

The drawing size calculator 16 calculates a drawing size of the block element detected by the document structure analysis, and determines a block element to be area-focused (step S400). The block element to be area-focused is of the layer 2, i.e., an internal block element, and has an area that is a greatest one of the display areas of the block elements of the layer 2. Thus, the drawing size calculator 16 obtains display areas for all the block elements of the layer 2, and determines the element having the greatest one of the display areas as the block element to be area-focused. The block element is determined in accordance with the flow illustrated in FIG. 7. The flow of the determination will be described later.

The visible/hidden processor 18 performs a visible/hidden process of the block elements and changes a drawing size of the block element to be area-focused (step S500). In the visible/hidden process of the block elements, the visible/hidden processor 18 adds a property of being hidden to the style sheet for the block elements other than the block element to be area-focused so as to give the hidden property, and adds nothing for the block element to be area-focused. As it is specified that all the block elements are displayed in the style sheet acquired at the step S200, it is enough to provide only the block elements to be rendered hidden with the property of being hidden. The change of the drawing size is a process for changing the size written in the style sheet in accordance with the width of the screen G of the display 22 of the document display device 10.

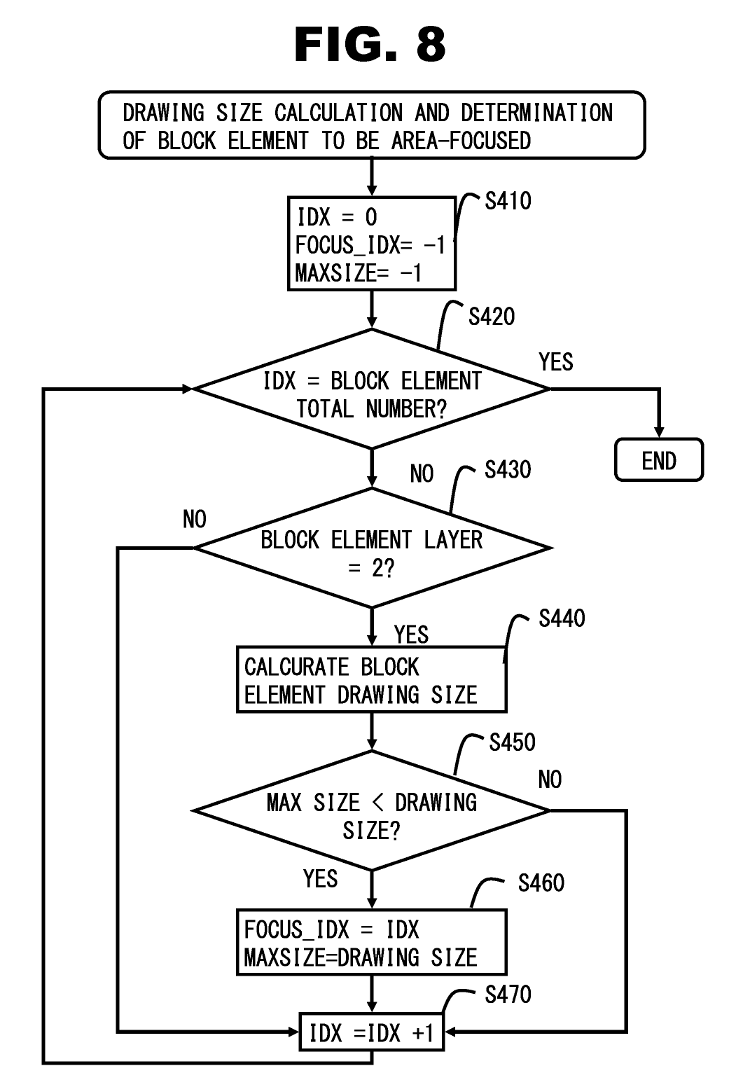

The visible/hidden process and the change of the size are performed in accordance with a flow illustrated in FIG. 8. The flow will be described later.

Finally, the drawing controller 20 displays the HTML document on the screen G of the display 22 by applying the style sheet corrected at the step S500 (step S600).

Thus, a portion of the HTML document that a user wants to read is displayed in the mobile display mode in which the block element having the greatest area among the block elements of the layer 2 is caused to be the visible element, and the other elements are rendered hidden.

(Explanation of the Document Structure Analysis)

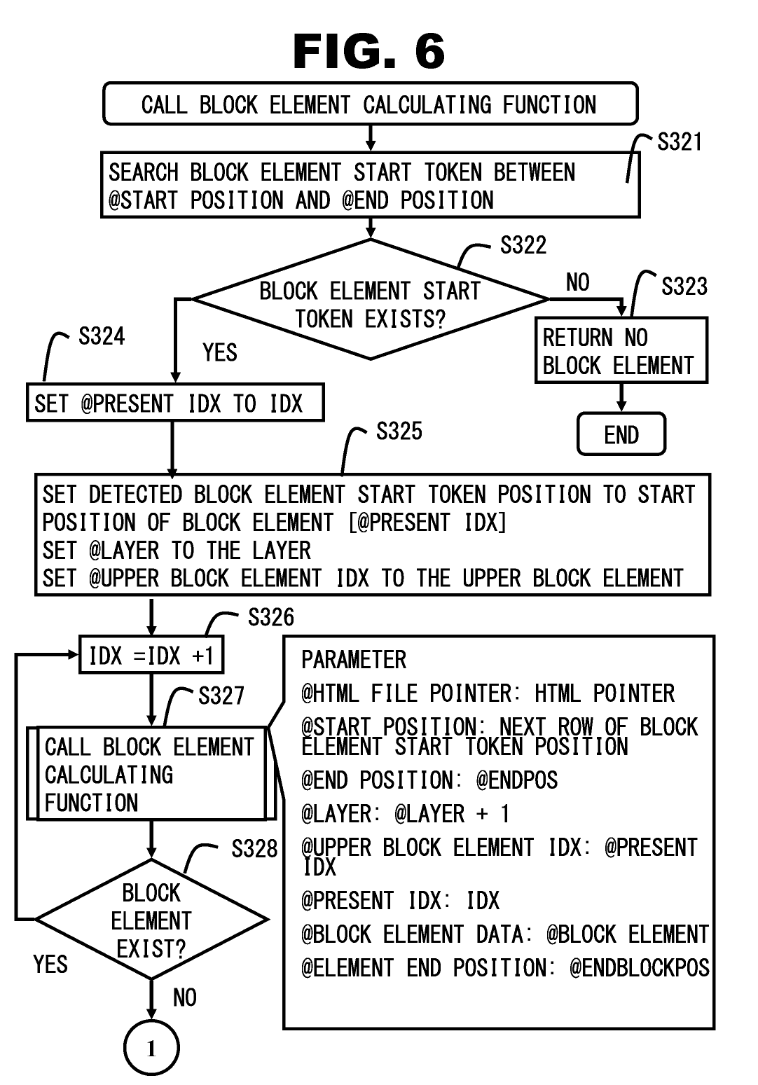

FIGS. 5, 6 and 7 illustrate a flow of the document structure analysis at the step S300 illustrated in FIG. 3A, FIG. 3B, and FIG. 3C. The flow illustrated in FIGS. 6 and 7 divides a process of a step S320, and FIGS. 6 and 7 illustrate former and latter portions of the flow, respectively.

At first, as illustrated in FIG. 5, Idx=0, StartPos=0 and EndPos=end position (row) of the HTML file (document data) are set as initial settings (step S310).

Then, the block element calculating function is called (step S320). The block element calculating function is a subroutine configured to return block element data including whether or not a block element exists as a processing result upon a value being set to each of variables. When the block element calculating function is called, as illustrated in FIG. 5, a value is set to each of parameters explained below and is provided to the block element calculating function. Specifically, a pointer of the HTML file is specified as @HTML pointer, StartPos is specified as @start position, EndPos is specified as @end position, a value 1 is specified as @layer, a value 0 is specified as @upper block element Idx and EndBlockPos is specified as @element end position.

Due to the call of the block element calculating function, the block element data including the data of whether or not a block element exists is returned. Specifically, a value and so on is set to each of the above parameters and returned. A process performed due to the call of the block element calculating function is performed in accordance with the flow illustrated in FIGS. 6 and 7, and will be explained later.

Data of whether or not a block element exists is determined on the basis of the block element data obtained due to the call of the block element calculating function (step S340). If a block element exists, a position (row) where a value 1 is added to @element end position (row) of the block element is set as StartPos from the block element data (step S350), and the block element calculating function is called again at the step S320 so that the process illustrated in FIG. 6 is performed. The block element detected due to the call of the block element calculating function at the step S320 corresponds to an external block element specified on the layer 1 and a block element of the layer 2 having the above block element of the layer 1 as an upper block element. Thus, the process of the steps S320-S350 searches for a block element until there is no block element of the layer 1 while changing the position (row) at which the search for a block element starts, i.e., the position (row) of StartPos.

In a case of refusal at the step S340, i.e., where data of existence of no block element is returned, the block element total number is set as Idx (step S360). As Idx is provided with an addition of 1 each time a block element start token is discovered at a step S326, illustrated in FIG. 6 and described later, the value of Idx corresponds to the block element total number detected so far.

Due to the above process, the block element data including the data of whether or not a block element exists, the block element total number, the start position (start row) in the HTML document for each of the block elements, the end position (end row), the block element layer and the upper block element data is obtained, and the flow moves on to a step S400.

(Explanation of a Process Performed by the Block Element Calculating Function)

FIGS. 6 and 7 illustrate a processing flow of the block element calculating function called at the step S320. The block element calculating function performs the process by using a variable to which the initial value is set at the step S310 illustrated in FIG. 5.

In the processing flow illustrated in FIG. 6, first, a block element start token is searched for between the @start position and the @end position (step S321). As the block element start token, e.g., a start tag for which a property such as id or class is specified for div is listed.

Whether or not a block element start token exists is determined (step S322). If no block element start token exists, data of existence of no block element start token is set and returned as the block element data of the block element calculating function (step S323).

If a block element start token exists, a value of the @present Idx is set to Idx (step S324). If the process of the above steps S340 and S350 is never performed, as the value of the above variable Idx is 0, the value 0 is set to the @present Idx. Idx is a variable that represents the number of the block elements detected at present.

A value of the detected block element start token position (row) is set to the start position (row) of the block element at the @present Idx for which the block element start token is detected (step S325). Further, a value of the @layer is set to the layer. If the process of the steps S340 and S350 described above is never performed, the value of the @layer that is the above variable is 1, and is set as the external block element (step S325). If the process of the steps S340 and S350 described above is never performed, as the present value of the @upper block element Idx is 0, a value of the upper block element Idx is 0.

Idx is provided with an addition of a value 1 (step S326), and further, the block element calculating function is called (step S327). The call of the block element calculating function at the step S327 means that the block element calculating function is called again in the process performed by the block element calculating function called at the step S320. Due to this call of the block element calculating function, the internal block element corresponding to the layer 2 can be detected. Thus, the external block element of the layer 1 is detected due to the call of the block element calculating function at the step S320, and in that process the internal block element of the layer 2 is detected due to the call of the block element calculating function at the step S327. On the occasion of the call of the block element calculating function at the step S327, the detected block element data of the layer 1 is set as values of respective parameters.

Specifically, a value of a next row of the position of the block element start token of the layer 1 detected at the step S321 is set to the @start position. The @layer is set such that the value 1 of the present @layer is provided with an addition of 1, and a value 2 corresponding to the internal block element is set to the @layer. The value of the @present Idx is set to the @upper block element Idx. If the process of the steps S340 and S350 described above is never performed, the value of the @present Idx is 0, and the block element 0 is specified as the upper block element. The value of Idx is set to the @present Idx. If the process of the steps S340 and S350 described above is never performed, the value of Idx is 1 and the value 1 is set to the @present Idx.

As a result of the call of the block element calculating function, whether or not a return of block element existence is received is determined (step S328). If a block element exists, the flow returns to the step S326, Idx is provided with an addition of 1, and the value of the block element total number increases by 1. The step 327 and the step S328 are repeated until being refused by the determination at the step S328. The process of the steps S326-S328 is repeated so that all the block elements of the layer 2 (internal block elements) specified in the block elements of the layer 1 (external block elements) are detected.

As illustrated in FIG. 7, an end token is searched for between a next row of the @start position and the @end position (step S329). The end token to be an object of this search corresponds to the block element start token searched for at the step S321.

Whether or not a block element end token exists is determined (step S330). If a block element end token exists, a value of the position of the detected block element end token is set to the end position of the block element of the @present Idx and the @element end position (step S331).

If no block element end token exists, the value of the @end position is set to the end position of the block element of the @present Idx and the @element end position (step S332). After that, data of block element existence is set. The data is returned with data of the parameters as processing result data of the called block element calculating function (step S333).

At the step S327 in the process of the block element calculating function called at the step S320, further, the block element calculating function is called again. Due to the call of the block element calculating function for the second time, further, a process starts from the step S321. At the moment, further, the block element calculating function is called at the step S327. Due to repetitive calls of the block element calculating function, the layers of the block elements are rendered deep, and the value of the @layer increases as 2, 3, 4, or more. In this way, the block element calculating function is repetitively called at the step S327 in correspondence with the depth of the layered structure of the HTML document. Document data of the HTML document has, e.g., a two-layered structure, and a greatest value of the @layer is 2. Thus, the block element of the layer 2 is detected in the block element of the @present Idx, and the block element data is obtained.

What is described above is an explanation of the processing flow illustrated in FIG. 6 according to the step S320.

(Explanation of Drawing Size Calculation and Determination of Block Element to be Area-Focused)

FIG. 8 illustrates a processing flow of drawing size calculation and determination of a block element to be area-focused at the step S400.

In the process of determination of a block element to be area-focused, one of the block elements of the layer 2 of a greatest drawing size, i.e., of a greatest display area, is determined.

Values are each set to respective variables (step S410). Specifically, a value 0 is set to a variable Idx, a value −1 is set to a variable focus_idx, and a value −1 is set to a variable MaxSize.

Whether or not the value of the block element total number specified at the step S300 is equal to Idx is determined (S420). If the value of the block element total number is equal to Idx, the process ends and moves on to the step S500. If the present value of Idx is 0, and the block element total number is 0, i.e., no block element exists, the process ends and moves on to the step S500.

If the value of the block element total number is not equal to Idx, whether or not the block element identified by the value of Idx is a block element corresponding to the layer 2 is determined (step S430). If the layer of the block element is the layer 2, a drawing size of the block element corresponding to the value of Idx is calculated (step S440). As the width of the drawing size is written in the style sheet, the value of the width is picked up, further, data of the element start position and the element end position of the corresponding block element is used so that the total number of the rows of the corresponding block element is obtained, the value of the width and the total number of the rows are multiplied, and the drawing size that is the size of the display area is obtained.

The value of the variable MaxSize and the drawing size calculated at the step 440 are compared, and whether or not the drawing size is greater than the value of MaxSize is determined (step S450). If the drawing size is greater than the value of MaxSize, the value of Idx is set to focus_idx, and the value of the drawing size calculated at the step S440 is set to MaxSize (step S460). If the drawing size is not greater than the value of MaxSize, the flow moves on to a step S470 described later. Then, Idx is provided with an addition of 1 (step S470), and the flow returns to the step S420.

As the value of Idx increases one by one, the drawing size of the block element of the layer 2 is compared with MaxSize until the value of Idx reaches the block element total number, so that the block element of the greatest display area is obtained. This block element is identified by the value of focus_idx.

(Explanation of Visible/Hidden Process and Size Change Process)

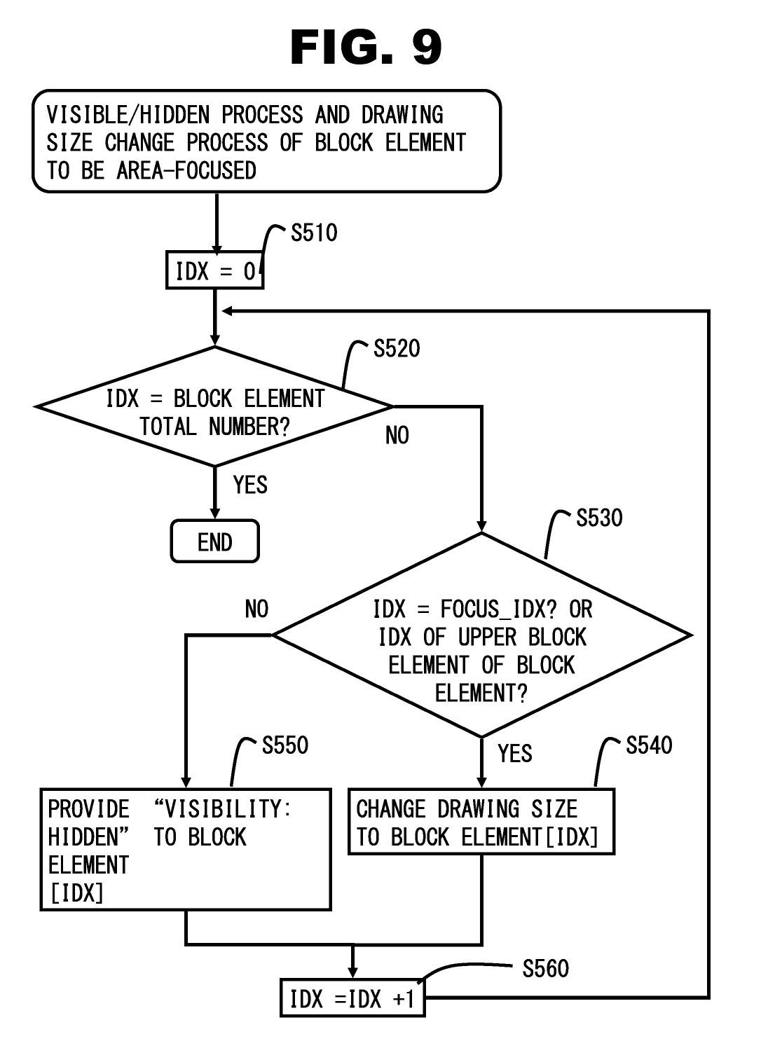

FIG. 9 illustrates a processing flow of the visible/hidden process and the process for changing the drawing size at the step S500.

The visible/hidden process performs a hidden process on a block element other than the block element to be area-focused, and the drawing size change process is a process for changing a size in accordance with the width of the screen G of the display 22.

A value 0 is initially set to the variable Idx (step S510).

Whether or not Idx agrees with the block element total number is determined (step S520). If the value of Idx agrees with the block element total number, the visible/hidden process and the drawing size change process end and the flow moves on to the step S600. If the value of Idx does not agree with the block element total number, whether Idx agrees with a value of focus_idx that identifies a block element to be area-focused, or whether Idx agrees with a value that identifies an upper block element of a block element to be area-focused is determined (step S530). As a result of the determination, if it agrees, the drawing size is changed under the condition that the corresponding block element identified by the value of Idx is a block element to be area-focused or its upper block element (step S540). As a result of the determination, if it does not agree, a property of being hidden is provided under the condition that the corresponding block element identified by the value of Idx is not a block element to be area-focused (step S550).

After that, the variable Idx is provided with an addition of 1 (step S560), and is returned to the step S520 again.

The process of the steps S530-S560 is repetitively performed until the value of Idx agrees with the block element total number.

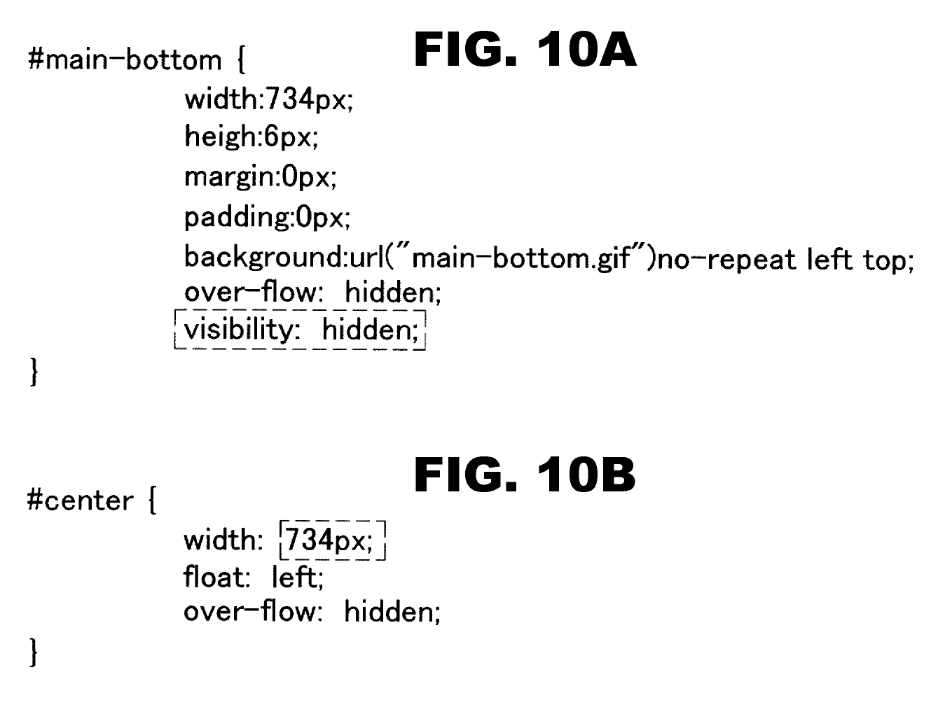

The property of being hidden is provided at the step S550, as illustrated in FIG. 10A, by an insertion of “visibility: hidden” into an entry in the style sheet. Meanwhile, the block element size is changed at the step S540, as illustrated in FIG. 9B, by a change of a value immediately after “width:”. As illustrated in FIG. 10B, e.g., it is changed from 516px to 734px.

If Idx agrees with the value that corresponds to the upper block element of the block element to be area-focused at the step S530, the drawing size is changed. The upper block element is not provided with a property of being hidden. The reason why is that the display of the block element of the layer 2 is not realized as a visible element in accordance with the width of the screen G unless not only the block element of the layer 2 but also the block element of the layer 1 that is its upper block element is changed in the drawing size and provided with a property of being visible.

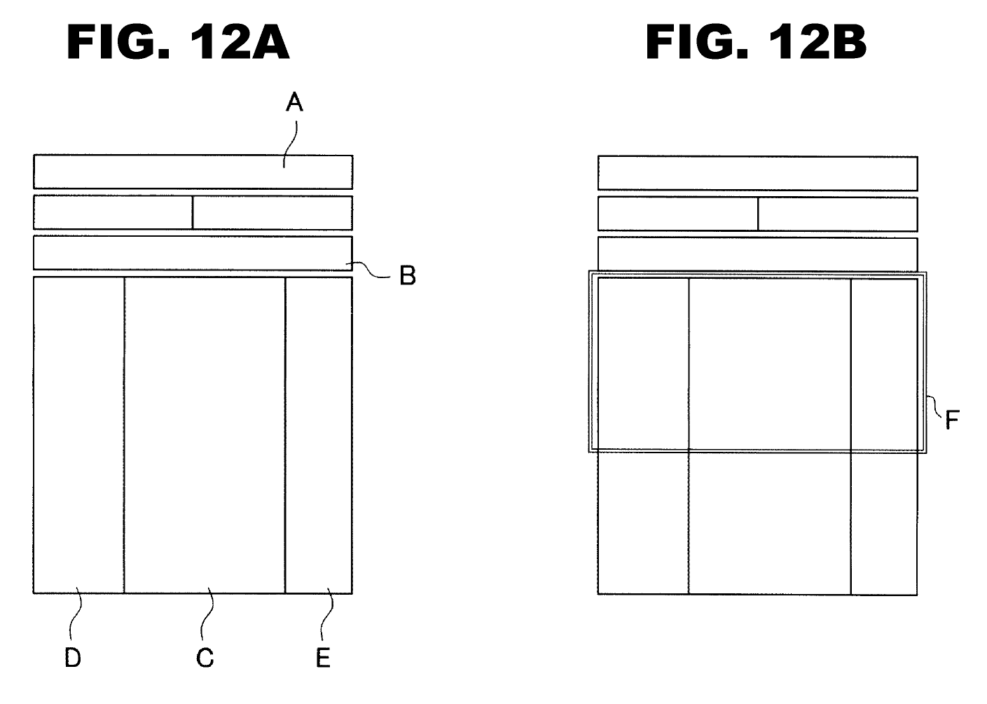

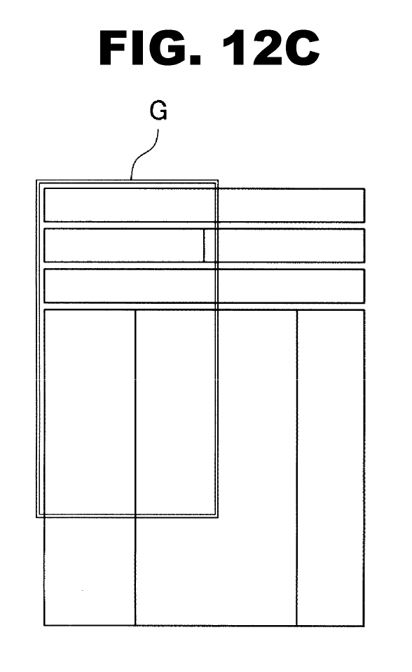

A block element of the layer 2 is searched for and detected in the document structure analysis, a detected block element is caused to be a visible element to be area-focused, and the other block elements are caused to be hidden elements. That is because, in an HTML document such as blog on the Internet, content of a document written in the internal block element of the layer-structured document data usually corresponds to the body that a user is interested in and wants to read. The document structure analysis of document data allows the body area of the document that the user wants to read to be efficiently displayed. Thus, it is unnecessary to vertically scroll quite often in comparison with the PC display mode illustrated in FIGS. 12B and 12C, and the content of the document can be easily read. Further, the block element size is changed in accordance with the width of the screen G when displayed. Thus, it is unnecessary to scroll horizontally.

The document display device and the method described above are a device and a method, respectively, that cause the one of the block elements of the layer 2 having a drawing size of a greatest area as an element to be area-focused. Other than that, however, the number of characters included in each of plural detected block elements of the layer 2 is obtained, an element having the greatest one of the number of characters is caused to be a visible element to be area-focused, and the elements other than the visible element can be caused to be hidden elements. In that case, a processing unit configured to count the number of characters of each of the block elements of the layer 2 and to specify one of the elements of the layer 2 having the greatest number of characters is can be provided instead of the drawing size calculator 16. A flow for counting the number of characters of each of the block elements of the layer 2 and for specifying one of the elements of the layer 2 having the greatest number of characters can be provided instead of the step S400 illustrated in FIG. 4.

The block element to be area-focused is not limited to a block element of the layer 2, and may be a block element of the layer 3, 4 and so on. It is allowed that a user can preset the layer of the block element to be area-focused.

The document displaying method described above takes an example of a block element specified by the style sheet, and can be applied to a frame element or a table element written in document data of a markup document such as an HTML document. As illustrated in FIG. 11A, e.g., it is assumed that gray areas C, D, E and areas H, I are specified by table elements, the areas C, D, E are specified by a table element of the layer 1, and in the above the areas C, D, E are separately specified as table elements of the layer 2. In that case, although it is primarily wished that the table element of the area C can be an object to be area-focused as illustrated in FIG. 11B, the areas C, D, E are detected as one table element to be area-focused as illustrated in FIG. 11C, which is a problem of related art and can be solved by performing a process similar to the document structure analysis described above, and a document that a user wants to read can be efficiently displayed.

The document display device 10 may further have a mobile display mode in which an element to be area-focused and the other elements are caused to be a visible element and hidden elements, respectively, and displayed in accordance with the width of the screen G and a PC display mode in which they are displayed in a display form according to a screen of a PC and so on that is wider than the screen G as illustrated in FIGS. 12B and 12C. In that case, it can be configured to change the display mode in accordance with an input direction that a user gives the input direction unit 24. The mobile display mode is effective in that a user reads document content, and the PC display mode is effective in that a user looks at or views a whole HTML document such as a blog. In that case, it is configured such that input direction data of the input direction unit 24 is sent to the visible/hidden processor 18 and the drawing controller 20, the visible/hidden processor 18 corrects the style sheet in correspondence with the PC display mode, and is displayed on the display 22 through the drawing controller 20.

In a case where, e.g., the document display device 10 is integrated in a mobile phone, let numeric keys of a mobile terminal device be the input direction unit 24, and it is configured such that a numeral “5” key is pressed so that a display on the screen G is changed from the PC display mode to the mobile display mode, and that the numeral “5” key is pressed again so that the display on the screen G is changed from the mobile display mode to the PC display mode. It can be configured such that, in a state of the mobile display mode, a numeral “4” key, a numeral “6” key, a numeral “2” key or a numeral “8” key that is adjacent to the numeral “5” key is pressed so that the visible element to be area-focused and displayed is changed to a block element being adjacent in the same direction as viewed from the place of the numeral “5” key. The display in this case is in the mobile display mode in accordance with the width of the screen G. As the document structure of the HTML document to be displayed is known due to the style sheet, the visible/hidden processor 18 and the drawing controller 20 can change the style sheet. That is, the document display device 10 can specify one hidden element being adjacent to a visible element that is being area-focused and displayed at present in accordance with an arrangement position of one numeral key that a user gives an input direction among the numeral keys that are plural input direction means, can cause the specified hidden element to be a new visible element, and can cause the elements other than the new visible element to be hidden elements and draw.

In a case where the document display device 10 has a plurality of screens as the display 22, it can be configured to always display in the PC display mode on one screen, and to display in the mobile display mode on another screen.

Incidentally, if an HTML document is displayed in the PC display mode, in accordance with an input direction from a user to a plurality of the input direction units 24 arranged at certain positions, a portion caused to be a visible element is specified in accordance with an arrangement position of one of the input direction units 24 that the user gives an input direction, and the portion may be displayed. In a case, e.g., the document display device 10 is integrated in a mobile phone, it can be configured such that positions of portions of the HTML document each correspond to arrangement positions of respective numeral keys “1”-“9”, “*”, “0” and “#”, and that the portion of the HTML document that corresponds to the position of the numeral key that the user has pressed is displayed.

A computer program that can be run by a computer that constitutes the document display device 10 is activated so that the processes of the document display device 10 described above can be implemented. Such a program can be implemented by including: a procedure for detecting one structural element as a first element by means of a process processor among a frame element specified by a markup language, a table element specified by the markup language and a style sheet in a document structure of document data written in the markup language, and for further detecting a structural element specified in the first element as a second element by means of the process processor, a procedure for setting a condition of causing the detected second element to be a visible element and for causing a structural element other than the visible element to be a hidden element to the document data by means of the process processor, and a procedure for displaying a document on a client terminal screen by using the document data to which the condition is set by means of the process processor.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions have been described in detail, it should be understood that the various changes, substitutions, and alterations could be made hereto without departing from the spirit and scope of the invention.

What is claimed is:

1. A device for displaying an image according to a document including a plurality of block elements on a display screen, each of the block elements defining an image of an object having a size relative to the size of the screen when displayed, the object being capable of being overlaid with a text or another image of another object, the device comprising:
a data acquisitor for obtaining the document; and
a processor for executing a process including:
extracting the plurality of the block elements from the document;
determining at least one of the plurality of the block elements defining an image of an object to be displayed on the display screen on the basis of size of the image of an object; and
displaying the image of the object defined by the at least one of the block elements determined together with any associated text or another image object of another object overlaid onto the image of the object.

2. The device according claim 1, wherein the determining determines at least one of the plurality of the block elements defining an image of an object to be displayed on the display screen on the basis of the number of characters included in the image of an object.

3. The device according claim 1, further comprising a input module for obtaining information for selecting the at least one of the plurality of the block elements, wherein the determining determines at least one of the plurality of the block elements defining an image of an object to be displayed on the display screen on the basis of the information.

4. The device according claim 1, wherein the process includes changing width of the image of the object defined by the at least one of the block elements such that the width matches the width of the display screen.

5. A method for controlling an device for displaying an image according to a document including a plurality of block elements on a display screen, each of the block elements defining an image of an object having a size relative to the size of the screen when displayed, the object being capable of being overlaid with a text or another image of another object, the method comprising:
obtaining the document;
extracting the plurality of the block elements from the document;
determining at least one of the plurality of the block elements defining an image of an object to be displayed on the display screen on the basis of size of the image of an object; and
displaying the image of the object defined by the at least one of the block elements determined together with any associated text or another image object of another object overlaid onto the image of the object.

6. The method according claim 5, wherein the determining determines at least one of the plurality of the block elements defining an image of an object to be displayed on the display screen on the basis of the number of characters included in the image of an object.

7. The method according claim 5, further comprising obtaining information for selecting the at least one of the plurality of the block elements, and wherein the determining determines at least one of the plurality of the block elements defining an image of an object to be displayed on the display screen on the basis of the information.

8. The method according claim 5, further comprising, changing width of the image of the object defined by the at least one of the block elements such that the width matches the width of the display screen.

9. A medium for storing a program for controlling an device for displaying an image according to a document including a plurality of block elements on a display screen, each of the block elements defining an image of an object having a size relative to the size of the screen when displayed, the object being capable of being overlaid with a text or another image of another object, the program executing a process comprising:
obtaining the document;
extracting the plurality of the block elements from the document;
determining at least one of the plurality of the block elements defining an image of an object to be displayed on the display screen on the basis of size of the image of an object; and
displaying the image of the object defined by the at least one of the block elements determined together with any associated text or another image object of another object overlaid onto the image of the object.

10. The medium according claim 9, wherein the determining determines at least one of the plurality of the block elements defining an image of an object to be displayed on the display screen on the basis of the number of characters included in the image of an object.

11. The medium according claim 9, wherein the process further includes obtaining information for selecting the at least one of the plurality of the block elements, and wherein the determining determines at least one of the plurality of the block elements defining an image of an object to be displayed on the display screen on the basis of the information.

12. The medium according claim 9, wherein the process further includes changing width of the image of the object defined by the at least one of the block elements such that the width matches the width of the display screen.
